(19) United States
(12) Patent Application Publication
(10) Pub. No.: US 2023/0217033 A1
(43) Pub. Date: Jul. 6, 2023

(54) STANDARDS-COMPLIANT ENCODING OF VISUAL DATA IN UNSUPPORTED FORMATS

(71) Applicant: Intel Corporation, Santa Clara, CA (US)

(72) Inventors: Palanivel Guruva reddiar, Chandler, AZ (US); Beenish Zia, Beaverton, OR (US)

(73) Assignee: Intel Corporation, Santa Clara, CA (US)

(21) Appl. No.: 18/182,796

(22) Filed: Mar. 13, 2023

Related U.S. Application Data
(60) Provisional application No. 63/319,542, filed on Mar. 14, 2022.

(51) Int. Cl. H04N 19/186; H04N 19/174; H04N 19/12

(52) U.S. Cl. CPC H04N 19/186; H04N 19/12; H04N 19/174

(57) ABSTRACT

Embodiments of standards-compliant compression of high-bit-depth visual data are disclosed herein. In one example, visual data is received in a first format, where the first format corresponds to a first color space having a first bit depth, and where the visual data is represented in the first color space. The visual data is rearranged from the first format into a second format, where the second format corresponds to a second color space having a second bit depth, and where the rearranged visual data in the second format remains represented in the first color space. The rearranged visual data in the second format is then encoded using a codec for the second color space.

### CROSS REFERENCE TO RELATED APPLICATION

This patent application claims the benefit of the filing date of U.S. Provisional Pat. Application Serial No. 63/319,542, filed on Mar. 14, 2022, and entitled “HIGH-THROUGHPUT, STANDARDS-COMPLIANT, LOW-POWER PIXEL PROCESSING UNIT FOR LOSSLESS COMPRESSION OF MEDICAL IMAGES AND VIDEOS,” the contents of which are hereby expressly incorporated by reference.

### BACKGROUND

Modern clinical practices rely on the ability to efficiently and cost-effectively capture, store, transmit, and manipulate growing volumes of medical image data, such as patient images and video captured via ultrasound, X-ray, computed tomography (CT) scanning, and magnetic resonance imaging (MRI). This has become even more critical due to the pandemic, which forced many medical professionals to work remotely and increased the industry’s reliance on telehealth technology.

While standards-based compression schemes play an important role in reducing the storage space, bandwidth, and computing resources required for medical image data, they fall short in addressing the needs of the industry. For example, medical image data is typically represented in monochrome format with high bit depth, such as 16 bits or more per pixel. Further, practical and regulatory considerations often require medical image data to be processed and delivered with extremely low end-to-end latency (e.g., from acquisition to display) using only lossless compression.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures.

FIG. 1 illustrates a pipeline for processing visual data in unsupported formats using standards-compliant codecs.

FIG. 2 illustrates a system for providing access to radiology images.

FIGS. 3A-B illustrate example medical datasets from a healthcare provider before and after applying client-side transfer functions.

FIGS. 4A-B illustrate the space savings achieved by various codecs when compressing medical image data with and without using the described solution.

FIGS. 5A-C illustrate examples of monochrome images rasterized as YCbCr data in YUV image format.

FIG. 6 illustrates an example of rearranging pixel data in an image from 16-bit monochrome format into 8-bit YUV 4:2:2 format for standards-compliant encoding.

FIG. 7 illustrates an example of a rendered frame in a low-latency use case.

FIG. 8 illustrates a flowchart for standards-compliant encoding of visual data in unsupported formats in accordance with certain embodiments.

FIG. 9 illustrates an overview of an edge cloud configuration for edge computing.

FIG. 10 illustrates operational layers among endpoints, an edge cloud, and cloud computing environments.

FIG. 11 illustrates an example approach for networking and services in an edge computing system.

FIG. 12A provides an overview of example components for compute deployed at a compute node in an edge computing system.

FIG. 12B provides a further overview of example components within a computing device in an edge computing system.

FIG. 13 illustrates an example software distribution platform to distribute software.

### EMBODIMENTS OF THE DISCLOSURE

Modern clinical practices rely on the ability to efficiently and cost-effectively capture, store, transmit, and manipulate growing volumes of medical image data, such as patient images and video captured via ultrasound, X-ray, computed tomography (CT) scanning, and magnetic resonance imaging (MRI), among other examples. This has become even more critical due to the pandemic, which forced many medical professionals to work remotely and increased the industry’s reliance on telehealth technology. As an example, medical image data needs to be efficiently transmitted to remote radiologists to enable them to quickly and accurately diagnose patients in real time. Efficiency is generally measured in terms of compression ratio, encode/decode time, and resource requirements.

Standards-based compression codecs that work across cloud and edge infrastructure play an important role in reducing the storage space, bandwidth, and computing resources required for medical image use cases, but they fall short in addressing the needs of the industry. For example, medical image data is typically represented in monochrome format with high bit depth, such as 16 bits or more per pixel. Further, practical and regulatory considerations often require medical image data to be processed and delivered with extremely low end-to-end latency (e.g., from acquisition to display) using only lossless compression. Current standards-based compression schemes are unable to satisfy these requirements, however, as they do not support low-latency, lossless compression of monochrome images with high bit depth.

For example, data compression standards such as Lempel-Ziv-Welch (LZW) and 7-Zip support lossless compression of image/video, but the end-to-end latency is high, as these standards exploit redundancy at the entire data set level.

Image compression standards, such as Joint Photographic Expert Group (JPEG) (e.g., JPEG, JPEG 2000, High-Throughput JPEG 2000 (HTJ2K), JPEG XL, JPEG-LS) and Portable Network Graphics (PNG), support lossy and lossless compression of images. For example, JPEG-LS supports lossless/near-lossless compression of continuous tone images. While these image compression standards achieve high compression ratios for still images, they generally lack support for lossless compression that also has low latency. Other discrete cosine transform (DCT)-based image compression standards provide “visually lossless” compression, which may lose a level of detail that can be crucial to medical professionals, particularly when zooming in or magnifying certain areas, and potentially leads to incorrect diagnoses. Some image compression standards, such as JPEG and PNG, only support lossless compression of color images (e.g., three channel red-green-blue (RGB) images). As a result, compressing monochrome images using these standards requires the missing color components to be added before compression, and subsequently removed after decompression (e.g., before displaying them on the receiver side), which reduces the net compression ratio and increases latency. Further, image compression standards are inefficient for video data, as they are incapable of exploiting temporal redundancy in video frames.

For medical video and image data with temporal redundancy, video compression standards are better suited than image compression standards, as video compression exploits the temporal redundancy among frames to achieve higher compression ratios. However, current video compression standards, such as H.264 Advanced Video Coding (AVC), H.265 High Efficiency Video Coding (HEVC), and AOMedia Video 1 (AV1), have a maximum bit depth of 14 and only support lossless encoding for YUV/RGB color formats. Due to the limitations on bit depth and color space for lossless mode, these video compression standards are natively unable to perform lossless compression of medical image data in 16-bit or higher monochrome format.

Accordingly, this disclosure presents embodiments of a high-throughput, low-power pixel processing unit (PPU) to enable standards-compliant encoding of unsupported image and video formats, such as lossless compression of medical image data represented in 16-bit monochrome color. In particular, the PPU acts as a preprocessor and postprocessor to any standards-compliant compression codec, while also providing support for “zero-latency” settings, which significantly improves the compression ratio while also satisfying lossless and end-to-end latency requirements. For example, prior to compression of a monochrome image, the PPU performs lightweight (e.g., low-complexity) compute to “reorganize” the bits/bytes of monochrome pixel data into a format supported by a particular standards-based codec. In particular, the PPU process involves finding the right arrangement of pixel data to maximize the compression ratio in a format that is compatible with the requirements of the particular codec. The PPU also signals, in the compressed bitstream, the scheme used to reformat the original image data. In this manner, after performing the decode process on the receiving end, a matching PPU reads the specified scheme from the bitstream and rearranges the pixel data back into the original (monochrome) format.

This solution provides numerous advantages. The PPU process is lossless and lightweight—it simply rearranges pixel data in an unsupported format into a format that a standards-based codec supports in lossless mode. The PPU is standards agnostic and can be paired with any image or video compression standard, including current MPEG and AOM video compression standards (e.g., H.264, H.265, AV1) in lossless and low-latency modes, as well as current image compression standards (e.g., JPEG, PNG). The compression ratio achieved is on par with heavy data compression schemes such as LZW, while still meeting the low-latency requirements of the medical industry.

This solution also supports a “partially lossless” mode, which uses fully lossless encoding to preserve features in key regions of interest (e.g., heart/lungs in an X-ray of a patient), while using lossy forms of encoding, such as “visually lossless” encoding, for the remaining regions. As a result, this mode provides the flexibility to achieve an appropriate balance between quality and compression ratio for different regions of an image or frame. In some embodiments, the PPU may also leverage cache-assist techniques to improve performance on the client device, which further improves end-to-end latency.

This solution is applicable to numerous use cases, including high-bit-depth video scenarios (e.g., medical imaging), low-latency applications (e.g., cloud gaming), and distributed video analytics scenarios (e.g., video surveillance and retail audience analytics).

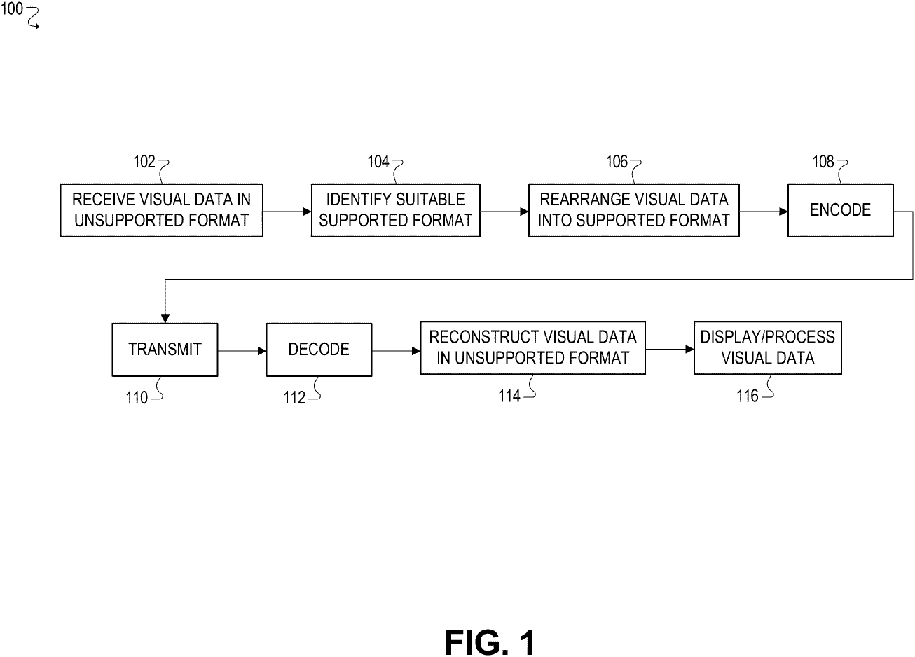

FIG. 1 illustrates a pipeline 100 for processing visual data in unsupported formats using standards-compliant codecs in accordance with certain embodiments. In some embodiments, this pipeline may be implemented on any system by simply incorporating a lightweight pixel processing unit (PPU) (e.g., in hardware or software) before the encoder on the encoding side, and after the decoder on the decoding side, to convert the image data between its original unsupported format and the alternative supported format before encoding and after decoding.

The pipeline begins at block 102 by receiving visual data in an unsupported format (e.g., a format not supported by a particular codec). Visual data may refer to any visual representation of information, such as an image, a video, a video frame, a tile or region of an image or video frame, and so forth. In some cases, for example, visual data may be captured by sensors (e.g., cameras, medical equipment, LIDAR/RADAR, thermal/infrared sensors) and/or synthetically generated (e.g., graphics/frames of video games, images/videos generated by generative models such as generative adversarial networks (GAN)).

Moreover, the visual data may be received in a format that is not supported by a particular image/video codec (e.g., H.264, H.265, AV1, VP9, JPEG, GIF, 7-Zip) or is not supported in a particular encoding mode of that codec (e.g., low-latency / lossless encoding). For example, the unsupported format may use a particular color space and/or bit depth that is not supported by the chosen codec.

As an example, the visual data may be medical image data captured by radiology equipment, which is often represented in monochrome color with a high bit depth, such as 16-bit monochrome (e.g., a monochrome color space with 16 bits per pixel) or higher. Existing codecs, however, do not support low-latency, lossless encoding of visual data represented into 16-bit monochrome color.

At block 104, an alternative format supported by the chosen codec and suitable for encoding the visual data is identified. For example, the chosen codec may support various formats corresponding to different color spaces and bit depths, and one of those formats may be chosen as the alternative format used to encode the visual data.

In some embodiments, for example, various metrics associated with the visual data may be computed (e.g., sum of adjacent pixel error, a color conversion suitability factor), and based on those metrics, one of the color space formats supported by the codec may be selected as the alternative format.

In some cases, for example, the alternative format may correspond to a luminance-chrominance color space, a red-green-blue (RGB) color space, or a monochrome color space with a particular bit depth. For example, the alternative format may correspond to a luminance-chrominance color space, such as a YUV-based color space, with a particular bit depth and chroma subsampling scheme, such as YCbCr color with 8 bits per color component (bpc) and 4:2:2 chroma subsampling (8-bit YCbCr 4:2:2). As another example, the alternative format may correspond to an RGB color space with a particular bit depth, such as RGB color with 8 bits per color component (8-bit RGB). As another example, the alternative format may correspond to a monochrome color space with a particular bit depth, such as monochrome color with 8 bits per pixel (8-bit monochrome).

Further, in some cases, the number of pixels in the original format and the alternative format may differ in order for the original visual data to fit in the alternative format (e.g., due to differences in bit depth of the respective formats).

At block 106, the visual data is rearranged from its original (unsupported) format to the alternative (supported) format. However, the visual data is not fully converted from the original (unsupported) format to the alternative (supported) format. Rather, the visual data in the original format is merely rearranged into the alternative format using an arrangement of pixel data that is highly correlated when interpreted in the alternative format. In this manner, the rearranged visual data in the alternative format is still represented in the color space and bit depth of the original format, but the underlying pixel data has been rearranged to provide better correlation—and achieve a higher compression ratio—when encoded in the alternative format.

As an example, for visual data rearranged from monochrome format into YUV/YCbCr format, the bits of each pixel value in the monochrome channel may be partitioned into a luma channel, a blue chroma channel, and a red chroma channel.

Further, in some embodiments, before (or after) the pixel data is rearranged into the alternative format, additional processing may be performed to achieve a higher compression ratio, such as rotating the pixels by a certain angle to increase spatial redundancy. In this manner, pixels of the rearranged visual data in the alternative format are rotated relative to pixels of the visual data in the original format.

At block 108, the chosen codec is used to encode the rearranged visual data in the supported format. Further, metadata indicating the processing that was performed prior to encoding the visual data (e.g., source and target formats of the visual data, pixel rotation/translation, etc.) is included with the encoded visual data to enable the original visual data to be reconstructed on the decoding side. In some embodiments, the metadata may be encoded using existing fields of the particular coding format, such as the fields of an H.265 annotated regions supplemental enhancement information (ARSEI) message.

At block 110, the encoded visual data is transmitted to the appropriate destination, such as another component within the same device (e.g., a storage medium on the same device), another device at the edge and/or on the same local network (e.g., an edge server used to store, process, and/or distribute the visual data), and/or a remote destination over a network (e.g., the cloud, a client device of an end user), among other examples.

At block 112, the encoded visual data is decoded using the appropriate codec (e.g., the same codec used during encoding) to extract the rearranged visual data in the supported format.

At block 114, the decoded visual data in the supported format, along with the metadata regarding the processing that was performed prior to encoding (e.g., source and target formats, pixel rotation/translation, and/or any other processing), is used to reconstruct the visual data in its original (unsupported) format. For example, based on the metadata, the processing performed prior to encoding is mirrored on the decoded visual data to transform it back into its original (unsupported) format.

At block 116, the reconstructed visual data is displayed and/or processed (e.g., using video analytics) in its original (unsupported) format.

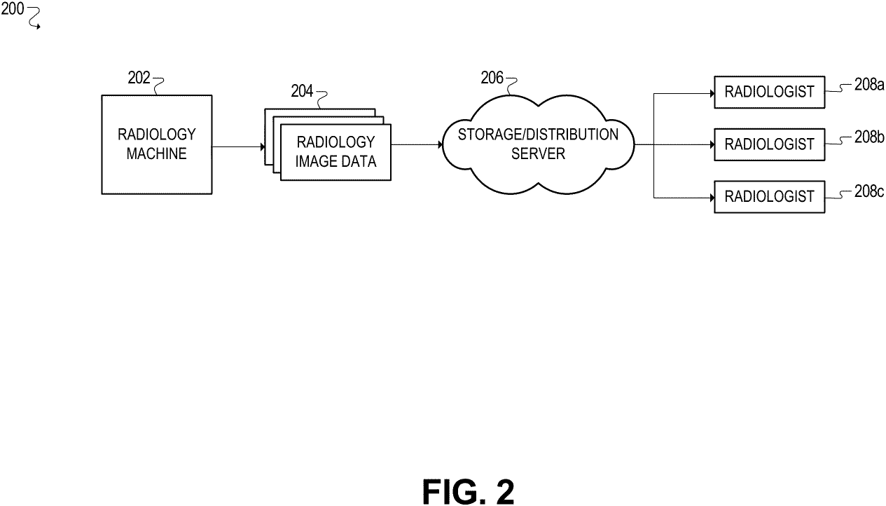

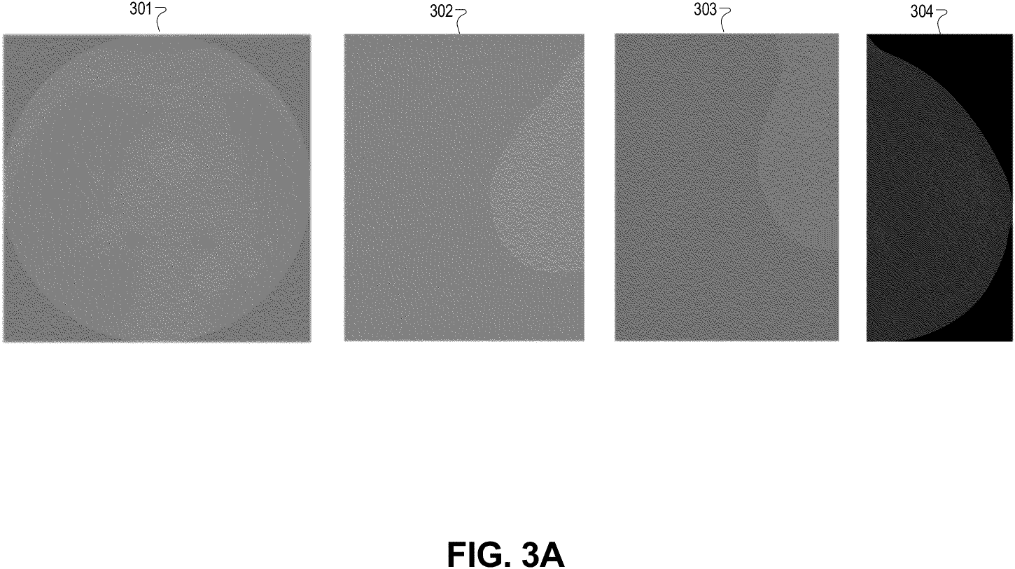

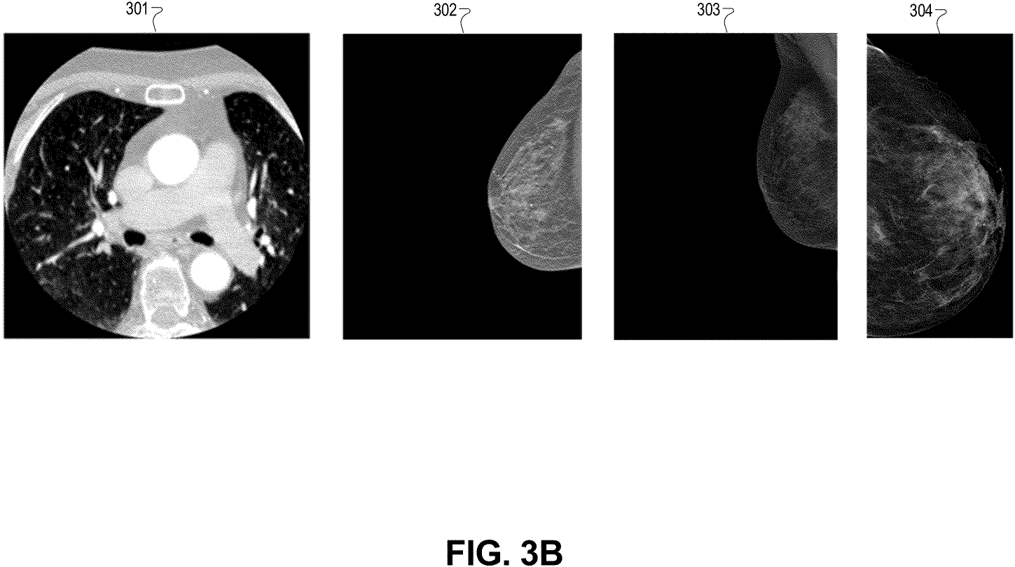

To illustrate, an example use case for medical image data is described in further detail in connection with FIGS. 2, 3A-B, and 4A-B.

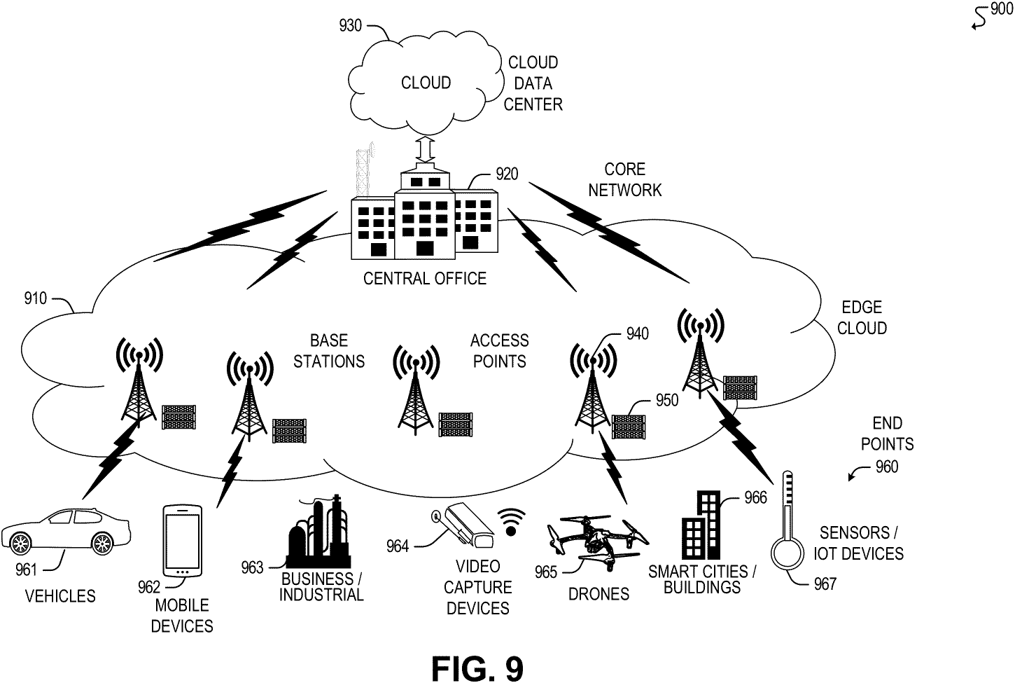

FIG. 2 illustrates a system 200 for providing radiologists and other medical professionals with access to radiology images. In the illustrated embodiment, a radiology technician uses a radiology machine 202 (e.g., ultrasound, X-ray, CT scan, or MRI equipment) to capture radiology image data 204 (e.g., images/video) of a patient. After some initial processing is performed (e.g., preprocessing, reconstruction, compression/encoding), the radiology image data 204 is uploaded to a storage/distribution server or cluster 206, such as a picture archiving and communications system (PACS), which may be hosted locally (e.g., on an on-premise edge server) or remotely (e.g., on a cloud server). The radiology image data 204 is then encoded or transcoded (e.g., decoded and then re-encoded in another format) by the distribution server 206 and sent to one or more radiologists 208a-c, who may be on premises (e.g., connected via a local network) or remote (e.g., connected via the cloud). For example, the radiologists 208a-c may be provided with secure access to the distribution server 206 via a web-based application on a client device. In some embodiments, for example, the distribution server 206 and/or radiologist devices 208a-c may be implemented using the edge and/or cloud computing embodiments of FIGS. 9-12.

This approach provides the flexibility to access radiology image data 204 from any geographic location using any type of device, both on premises and in remote locations. Further, this approach can be easily adapted to a variety of use cases, including efficient access to patient studies from anywhere within a clinical network and beyond, cost-effective retrieval from long-term storage, and image sharing for collaborative studies.

In this topology, upload bandwidth (e.g., bandwidth for uploading the radiology image data 204 to the distribution server 206) is often less of a concern than download bandwidth (e.g., bandwidth for downloading the radiology image data 204 from the distribution server 206 to the radiologist devices 208a-c). For example, if the distribution server 206 is hosted locally or on premise, upload bandwidth is not an issue. If the distribution server 206 is hosted in the cloud, plenty of upload bandwidth is typically available, and the cost of that bandwidth is usually covered by the cloud service provider (CSP) rather than the solution provider. On the other hand, download bandwidth is outside the control of the solution provider, as are the client devices used by the radiologists 208a-c.

Nonetheless, the medical image data 204 must be encoded by the distribution server 206, transmitted to the radiologists 208a-c, and then decoded and displayed on the client devices of the radiologists 208a-c, using only lossless compression and with low latency from end to end (e.g., fast encode/decode and data transmission times).

These considerations require the use of efficient codecs that support low-latency, lossless coding of high-bit-depth monochrome data, independent of client hardware/software. As explained above, no standards-based codecs are natively capable of meeting all of these requirements. However, processing pipeline 100 of FIG. 1 can be used to enable any standards-based codec to meet these requirements.

To illustrate, an example use case will be described using four medical datasets 301, 302, 303, 304 from a healthcare provider, which are shown in FIGS. 3A-B. FIG. 3A shows the four datasets 301-304 as captured by the medical equipment (e.g., a radiology machine), while FIG. 3B shows the four datasets 301-304 after applying additional client-side transfer functions for display to a radiologist. Typically, a wide variety of transfer functions are applied to the image data before it is displayed. Thus, on the client side, the functionality of the described solution (e.g., a pixel processing unit) can be easily integrated with the suite of existing transfer functions in a seamless manner.

Each medical dataset 301-304 contains 16-bit monochrome still images or video frames, although only one image/frame from each dataset is shown for simplicity. The objective is to encode these medical datasets with low latency and high compression ratios, while also meeting regulatory requirements for compression of medical image data to be lossless at the bit level. This mandate is in contrast to other usages that can use “visually lossless” modes, defined as having image deterioration that is imperceptible to humans. The higher computational requirements for lossless compared to lossy compression contribute to the challenges of delivering high compression ratios with fast encoding and decoding times.

While no standards-based codecs are natively capable of meeting all these requirements for 16-bit monochrome image/video data, the functionality of processing pipeline 100 enables standards-based codecs to meet these requirements.

First, each medical image dataset 301-304 is analyzed to identify an alternative color space format that is supported by the desired compression codec and is suitable for rearranging and encoding the pixel data. For example, the target color space format may be identified by computing various metrics on an image tile, such as sum of adjacent pixel error, color conversion suitability factor, and so forth. In this context, an “image tile” may refer to an entire image or video frame from the medical datasets 301-304 for fully lossless mode, or a portion of an image or video frame for partially lossless mode. For example, in fully lossless mode, each image or frame is losslessly encoded in its entirety, while in partially lossless mode, key regions of interest (ROIs) in an image or frame (e.g., a patient’s heart or lungs in an X-ray) are losslessly encoded and the remaining regions (e.g., the background and/or other unimportant features) are encoded using lossy forms of encoding, such as “visually lossless” encoding.

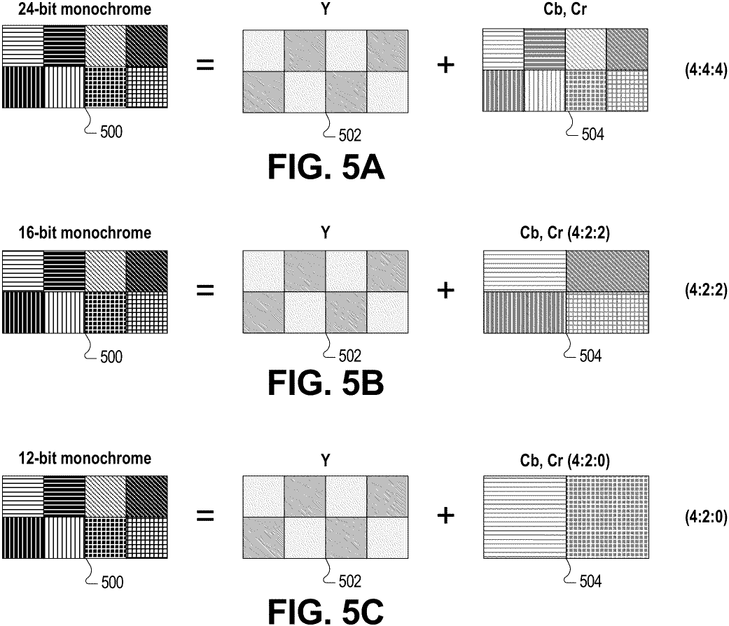

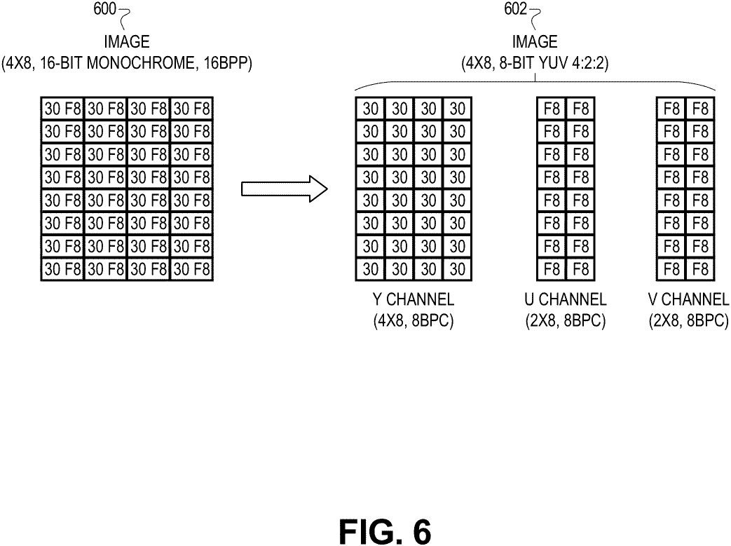

After a supported color space format suitable for standards-compliant encoding is identified, the pixel data in the image tile is rearranged into the supported color space format in an arrangement where the resulting pixel data is highly correlated. As an example, an image tile represented in 16-bit monochrome color may be rearranged into the format used for 8-bit YUV 4:2:2 color. Various examples of monochrome pixel data rasterized as YCbCr data (the combination of ‘Y’ and ‘Cb/Cr’ components) in YUV format are shown in FIGS. 5A-C, and an example of how monochrome pixel data may be rearranged in YUV format is shown in FIG. 6.

Further, in some embodiments, before (or after) the pixel data of the image tile is rearranged into the new format, additional processing may be performed on the pixel data to achieve a higher compression ratio, such as rotating the pixels by a certain angle to increase spatial redundancy.

The modified pixel buffer containing the rearranged pixel data in the supported color space format is then fed to the encoder, which encodes the rearranged pixel data into an encoded bitstream using the desired standards-based encoding scheme.

The encoded bitstream is then transmitted to the appropriate destination, along with metadata specifying the processing that was performed on the original image tile, which enables it to be reconstructed on the receiving end. For example, the metadata may specify the source and target pixel formats of the image tile, along with any other processing that was performed, such as pixel rotation/translation. In this manner, on the receiving end, the encoded bitstream is decoded into the rearranged pixel data using the standards-based coding scheme, and the rearranged pixel data is then reconstructed into the original pixel data using the metadata regarding the source/target formats and any other processing that was performed.

In some embodiments, the metadata may be in the form “SOURCE FORMAT: TARGET FORMAT,” as shown by the examples in Table 1. Further, in some embodiments, this metadata may be sent using existing fields of standards-based codecs, such as an H.265 annotated regions supplemental enhancement information (annotated regions SEI or ARSEI) message.

An ARSEI message is used to define an annotated region in an image/video frame. For example, an ARSEI message includes various fields that specify the size and position of a bounding box around a region of interest (e.g., an object), along with corresponding annotations. The fields of an ARSEI message include an identifier (id), x and y coordinates or offsets of the region of interest within the image/frame, the width (w) and height (h) of the region of interest, and a label to provide annotations.

In some embodiments, the label field of an ARSEI message may be used to specify the source and target formats of the image tile. In fully lossless mode, for example, a single ARSEI message may be used to specify the source/targets formats for an entire image or video frame. Alternatively, in partially lossless mode, multiple ARSEI messages may be used to specify the source/target formats for each separately-encoded region of the image or video frame.

TABLE 1

Example source/target pixel formats and corresponding ARSEI-coded labels

| | | | |
|---|---|---|---|
| SOURCE FORMAT | TARGET FORMAT | ARSEI LABEL FIELD | DESCRIPTION |
| AV_PIX_FMT _GRAY16LE | AV_PIX_FM T_YUV422 | AV_PIX_FMT_GRAY16LE: AV_PIX_FMT_YUV422 | 16-bit monochrome image formatted as 8-bit YUV 4:2:2 image |
| AV_PIX_FMT _GRAY16LE | AV_PIX_FM T_YUV422_ ROTATE_90 | AV_PIX_FMT_GRAY16LE: AV_PIX_FMT_YUV422_RO TATE_90 | Same as above, plus 90° pixel rotation |
| AV_PIX_FMT _GRAY16LE | AV_PIX_FM T_RGB565 | AV_PIX_FMT_GRAY16LE: AV_PIX_FMT_RGB565LE | 16-bit monochrome image formatted as 16-bit RGB image |

On the receiving end, the metadata regarding the source/targets formats (along with any other processing such as pixel rotation) is used to reconstruct the original image tile. For example, the encoded bitstream is decoded into the rearranged pixel data using the standards-based codec, and the rearranged pixel data is then reconstructed into the original image tile using the metadata regarding the source/target formats and any other processing that was performed. As an example, if the source format is 16-bit monochrome color and the target format is 8-bit YUV 4:2:2 color, the rearranged pixel data is converted from its 8-bit YUV 4:2:2 color format back to the original 16-bit monochrome color format. Further, if any other processing such as pixel rotation/translation was performed on the image tile prior to encoding, that processing is mirrored on the receiving end to restore the pixel arrangement in the original image tile.

Further, in addition to rearranging/reformatting pixels of medical image data into supported encoding formats, cache-assist techniques may be used to further reduce end-to-end latency. For example, when medical image data is captured, resource-efficient artificial intelligence algorithms may be used at the edge to identify key region(s) of interest in the medical image data. The PPU consumes both the pixel data and the metadata regarding the regions of interest, optionally rotates the regions of interest, and then rearranges pixels in the regions of interest into a supported encoding format.

In some cases, for example, by rotating the identified regions of interest, the pixels in those regions may occupy more of the cache area on the decoder side, leading to fewer cache misses and improved memory bandwidth. Further, the PPU on the encoder side may explicitly signal the PPU on the decoder side to keep the pixels in the regions of interest in the cache (e.g., using a “KEEP DATA _IN_CACHE” label in an ARSEI or other SEI message).

Further, in anticipation of the typical sequence of events performed by radiologists, the PPU rearranges and encodes the pixels in the regions of interest at a higher bit depth than the remaining regions (e.g., using the pixel rearrangement functionality described herein), while also signaling the source and target formats of those regions in the encoded bitstream. On the decoder side, the regions of interest are decoded and then reconstructed back into the original high-bit-depth format using the metadata regarding the source and target formats, thus preserving the details of the important regions. There is a high probability that a radiologist will perform operations over the key regions of interest identified on the capture side, such as magnifying or zooming in on areas of the heart. Thus, preserving the details of those regions on the decoder side (e.g., on client devices of the radiologists) leads to an improved user experience for radiologists.

In this manner, the decoder compute and end-to-end latency is reduced using cache-assist techniques and intelligent rearrangements of pixel data to efficiently compress key regions of interest without losing quality, thus improving the user experience on the decoder side. This approach can also be applied to other use cases that benefit from losslessly preserving key regions of interest in video/image data throughout an encoding/decoding pipeline.

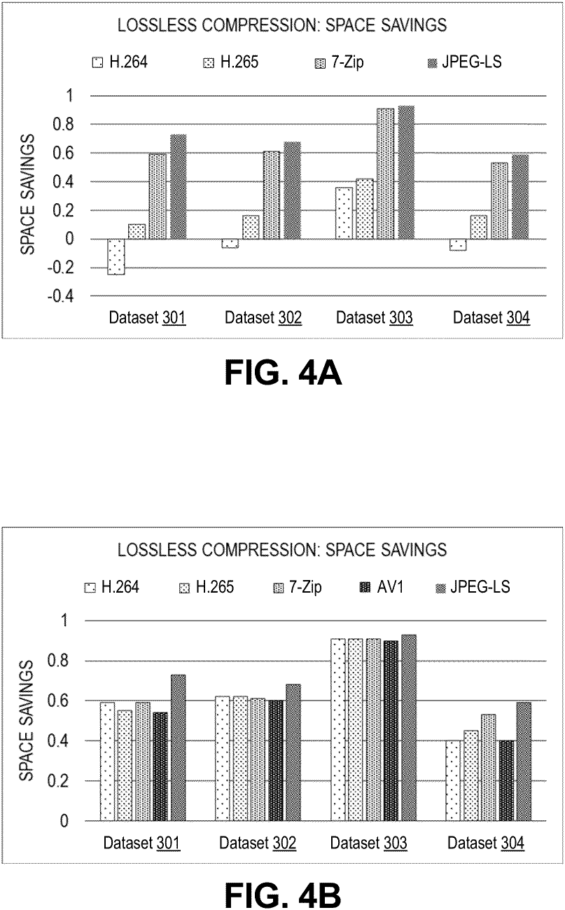

FIGS. 4A-B illustrate the space savings achieved by various codecs when compressing medical image data with and without using the described solution. In these examples, the codecs are used to compress medical images from datasets 301, 302, 303, and 304 of FIGS. 3A-B, which are represented in 16-bit monochrome color.

FIG. 4A illustrates the space savings achieved by H.264, H.265, 7-Zip, and JPEG-LS when compressing medical image datasets 301-304 without using the described solution. Since these standards-based codecs do not support lossless encoding of image data represented in 16-bit monochrome color, the original 16-bit monochrome image data is simply treated as 8-bit YUV 4:2:2 image data (without modification) when fed into the encoder. The total number of pixels remains the same between the two formats, and the interpreted pixel data is compressed using encoder settings for zero-latency, lossless, and very fast encoding.

As shown by these results, the space savings achieved by H.264 and H.265 is extremely poor compared to 7-Zip and JPEG-LS. For example, H.264 generated compressed size results that were larger than the corresponding uncompressed sizes in three out of the four test cases, while H.265 provided only 10-20% space savings in three test cases and approximately 40% in the fourth case. On the other hand, 7-Zip and JPEG-LS do not support low-latency encoding and are not designed to exploit temporal redundancy across multiples images or video frames, making them poor choices for low-latency compression of medical images and videos with temporal redundancy.

FIG. 4B illustrates the space savings achieved by H.264, H.265, AV1, 7-Zip, and JPEG-LS when compressing medical image datasets 301-304 using the described solution. For example, before encoding, a pixel processing unit (PPU) analyzes the 16-bit monochrome frames in datasets 301-304 and finds high correlation among the most significant bits (MSBs) of the monochrome pixels and high correlation among the least significant bits (LSBs) of the monochrome pixels, but low correlation between the MSBs and LSBs. As a result, the PPU rearranges the 16-bit monochrome pixel data into the format used for 8-bit YUV 4:2:2 color (which is supported by the encoder), with the MSBs of each monochrome pixel treated as the luminance (Y) channel and the LSBs of each monochrome pixel treated as the blue/red chrominance channels (Cb and Cr), or vice versa. This arrangement of pixel data has better correlation for encoding purposes when the frames are interpreted as pixel bitstreams represented in 8-bit YUV 4:2:2 color, which increases the compression ratio and space savings achieved by the encoded bitstream.

For example, each frame of rearranged pixel data is fed into the encoder and encoded in 8-bit YUV 4:2:2 color mode using a standards-compliant codec (e.g., with settings for zero-latency, lossless, and very fast encoding). Further, the respective formats of the original pixel data and the rearranged pixel data are encoded as metadata in the encoded bitstream, such as in the label field of an ARSEI message. In this manner, after decoding, the original pixel data can be reconstructed from the rearranged pixel data before display or further analysis.

As shown in FIG. 4B, when the described solution is used, the space savings achieved by H.264, H.265, and AV1 are comparable to those achieved by 7-Zip data compression and JPEG-LS image compression. For example, H.264, H.265, and AV1 generated compression ratios of 40-60% for three of the four test cases and approximately 90% for the fourth case. These results also demonstrate that this solution is compatible with any standards-based codec, as H.264 and H.265 are MPEG standards while AV1 is an AOM standard. Further, this solution enables hardware-accelerated decompression on the client side, as the encoded bitstreams are standards compliant and most client devices include fixed-function hardware to accelerate standards-compliant video/image coding schemes.

Further, by enabling standards-based video codecs to encode medical videos/images in unsupported formats, the similarity between adjacent frames is exploited during encoding, which further increases the resulting compression ratio and space savings. For example, in this context, frames can be temporally adjacent (e.g., as in a traditional video feed with a sequence of frames) or spatially adjacent (e.g., a two-dimensional (2D) or three-dimensional (3D) model composed of multiple frames stitched together).

FIGS. 5A-C illustrate various examples of monochrome images rasterized as YCbCr data (e.g., the combination of ‘Y’ and ‘Cb/Cr’ color components) in YUV image format using various subsampling schemes. In this disclosure, YUV generally refers to any color space or format that encodes brightness and color information separately (e.g., using luminance (luma) and blue/red chrominance (chroma) values), including, without limitation, YUV, YCbCr, and YPbPr. Moreover, a subsampling scheme is typically expressed as a three-part ratio J:a:b (e.g., 4:2:2), which represents the number of luminance and chrominance samples in a conceptual region with a width of J pixels and a height of 2 pixels, where a represents the number of chrominance samples (Cr, Cb) in the first row of J pixels, and b represents the number of changes of chrominance samples (Cr, Cb) between first and second row of J pixels.

For example, FIG. 5A illustrates a 24-bit monochrome image rasterized in 8-bit YUV format with 4:4:4 chroma subsampling. In FIG. 5A, each 24-bit monochrome pixel 500 is treated as the combination of 8-bit luma (Y) 502 and blue/red chroma components (Cb, Cr) 504, where the chroma components (Cb, Cr) 504 are sampled at the same rate/resolution as the luma component (Y) 502 (e.g., with no chroma subsampling). For example, the first 8 bits of each 24-bit monochrome pixel may be treated as the luma (Y) channel, the second 8 bits of each monochrome pixel may be treated as the blue chroma (Cb) channel, and the third 8 bits of each monochrome pixel may be treated as the red chroma (Cr) channel.

FIG. 5B illustrates a 16-bit monochrome image rasterized in 8-bit YUV format with 4:2:2 chroma subsampling. In FIG. 5B, each 16-bit monochrome pixel 500 is treated as the combination of 8-bit luma (Y) 502 and blue/red chroma components (Cb, Cr) 504, where the chroma components (Cb, Cr) 504 are subsampled at half the horizontal sampling rate of the luma component (Y) 502. For example, the first 8 bits of each 16-bit monochrome pixel may be treated as the luma (Y) channel, the second 8 bits of half of the monochrome pixels may be treated as the blue chroma (Cb) channel, and the second 8 bits of the other half of the monochrome pixels may be treated as the red chroma (Cr) channel.

FIG. 5C illustrates a 12-bit monochrome image rasterized in 8-bit YUV format with 4:2:0 chroma subsampling. In FIG. 5C, each 12-bit monochrome pixel 500 is treated as the combination of 8-bit luma (Y) 502 and blue/red chroma components (Cb, Cr) 504, where the chroma components (Cb, Cr) 504 are subsampled at half the horizontal and vertical sampling rates of the luma component (Y) 502. For example, the first 8 bits of each 12-bit monochrome pixel may be treated as the luma (Y) channel, the last 4 bits of half of the monochrome pixels may be treated as the blue chroma (Cb) channel, and the last 4 bits of the other half of the monochrome pixels may be treated as the red chroma (Cr) channel.

FIG. 6 illustrates an example of rearranging pixel data in an image from 16-bit monochrome format into 8-bit YUV 4:2:2 format for standards-compliant encoding. For purposes of this example, an image may refer to an image, a video frame, a tile of an image or video frame, or any other contiguous block of visual data.

In the illustrated example, the original image 600 is represented in 16-bit monochrome color (e.g., a monochrome color space with a bit depth of 16) and includes a 4x8 array of pixels that each have a 16-bit monochrome value. Since standards-based codecs lack native support for low-latency, lossless encoding of image data in 16-bit monochrome color, the pixel data of the monochrome image 600 is rearranged into the format of an image 602 represented in 8-bit YUV 4:2:2 color prior to encoding.

However, if the original 16-bit monochrome bitstream is simply treated as an 8-bit YUV 4:2:2 bitstream, the compression ratio would be poor due to low correlation between the resulting 8-bit pixel values in each channel. For example, in the original monochrome image 600, each pixel has the same 16-bit value, which is shown in hexadecimal format as ‘30 F8’. Here, there is high correlation among the most significant bits (MSBs) of the 16-bit values and high correlation among the least significant bits (LSBs) of the 16-bit values, but low correlation between the MSBs and LSBs of each 16-bit value, which a typical codec would try to take advantage of.

Thus, prior to encoding, the bit values of the 16-bit pixels in the monochrome image 600 are rearranged to treat the MSBs of each pixel as the Y channel and the LSBs of each pixel as the U and V channels (e.g., the LSBs of half of the pixels may be treated as the U channel and the LSBs of the other half of the pixels may be treated as the V channel) in an image 602 represented in 8-bit YUV 4:2:2 color. Other arrangements of the pixel data that provide high correlation are also possible.

In the resulting image 602, the 8-bit pixel values within the respective Y, U, and V channels are highly correlated, which significantly improves the compression ratio when encoded using a codec that supports 8-bit YUV 4:2:2 color.

After decoding, the pixel data in the 8-bit YUV 4:2:2 format 602 is rearranged back into the original 16-bit monochrome format 600 (e.g., for display/analytics).

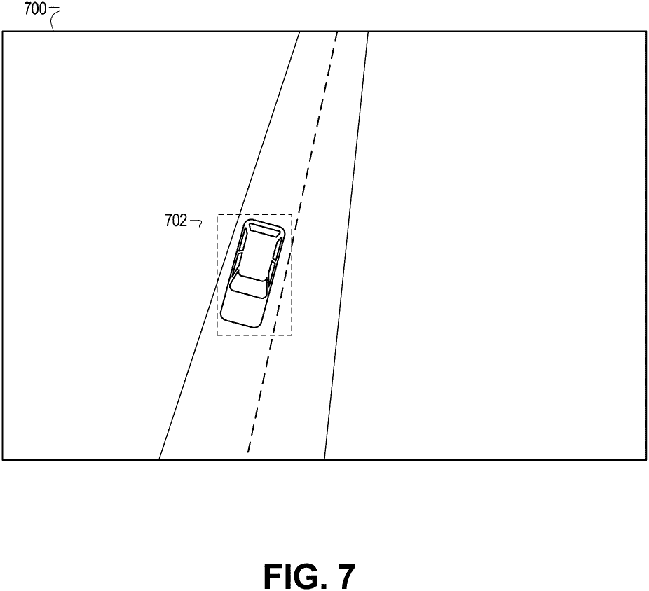

FIG. 7 illustrates an example of a rendered frame 700 in a low-latency use case (e.g., cloud gaming, visual analytics). In some embodiments, for example, the rendered frame 700 could be a video game frame in a cloud gaming use case or a video frame in a video analytics use case, which may be represented in an unsupported format (e.g., high-bit-depth color). Further, a pixel processing unit (PPU) may be used to enable the rendered frame 700, or a region of interest (ROI) 702 within the rendered frame 700, to be encoded using a standards-compliant codec. The PPU may also leverage cache-assist techniques to improve decoding performance on the receiving device, which improves end-to-end latency.

In a cloud gaming use case, for example, frames of a video game are rendered on a cloud server and then compressed and transmitted to a client edge device (e.g., video game console, digital media player, smartphone, tablet), which is typically controlled by a player. In the illustrated example, a sample rendered frame 700 is shown with an identified region of interest (ROI) 702. Similar to the medical imaging case, the region of interest 702 may optionally be rotated to increase spatial redundancy and achieve a higher compression ratio, and/or coded in an unsupported format (e.g., high bit depth) and reorganized into a supported format, and the region of interest 702 and its encoded format may be signaled in the encoded bitstream. Upon receiving the encoded bitstream, the client may use the ROI signaling to cache the pixels within the region of interest 702. Using the available pixel information (along with the high-bit-depth ROI pixels 702), the client device renders the frame without impacting latency since the ROI pixels 702 are already in the cache. If the ROI 702 changes (e.g., based on player behavior), the client device may request a newly-rendered frame from the cloud server. At this point, the cloud server re-executes the artificial intelligence algorithm to identify and encode the new ROIs, and the ROIs are then signaled in the encoded bitstream with the appropriate pixel arrangement to assist in effective caching on the client side (player side).

This approach is also applicable to distributed video analytics use cases, such as video surveillance and retail analytics. For example, in a surveillance use case, when a camera detects an object, it may send a video clip of the object to an edge server for further analysis, and the edge server may similarly send the video clip to the cloud for even more advanced analysis (e.g., performing facial recognition against millions of faces in a driver database to trigger an action for a traffic violation). In this case, a pixel processing unit (PPU) on the camera or edge server rearranges the pixels with higher bit depth and provides hints to the receiver’s caching mechanism, and as a result, the receiver is able to accomplish its task with much better accuracy and by consuming minimal compute resources.

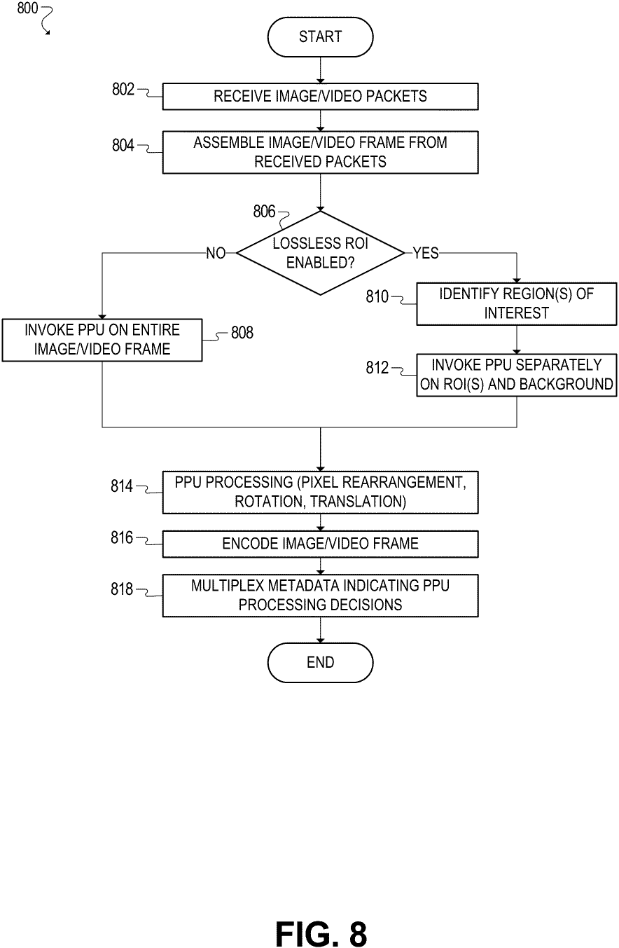

FIG. 8 illustrates a flowchart 800 for standards-compliant encoding of visual data in unsupported formats in accordance with certain embodiments. In some embodiments, for example, flowchart 800 may be performed to encode medical image data with high bit depth using a standards-compliant codec (e.g., using the example computing devices and systems described herein).

The flowchart begins at block 802 by receiving packets of an image or video frame. The flowchart then proceeds to block 804 to assemble the image or video frame from the received packets.

The flowchart then proceeds to block 806 to determine if lossless region-of-interest (RoI) encoding is enabled. If lossless RoI encoding is disabled, the flowchart proceeds to block 808 to invoke a pixel processing unit (PPU) on the entire image/video frame. If lossless RoI encoding is enabled, the flowchart proceeds to block 810 to identify or detect regions of interest in the video/image frame, and then to block 812 to invoke the PPU separately on (i) the identified regions of interest and (ii) the background, using lossless encoding for the regions of interest and visually lossless encoding for the background.

The flowchart then proceeds to block 814 to perform the PPU processing on (i) the entire frame or (ii) the regions of interest and the background separately. For example, the PPU processing may include color space reformatting / pixel rearrangement, rotation, translation, and so forth.

The flowchart then proceeds to block 816 to encode the image or video frame in the new format using a standards-based codec. In various embodiments, for example, the image or video frame may be encoded using any image/video compression/encoding scheme, including, without limitation, an image compression standard such as JPEG or PNG, a video compression standard such as H.264, H.265, AV1, or VP9, or another compression scheme/tool such as 7-Zip.

The flowchart then proceeds to block 818 to convert the PPU processing decisions (e.g., source/target color space formats, region-of-interest rotation/translation) into metadata and multiplex the metadata with the encoded image/video frame. In some embodiments, for example, the metadata may be specified using the fields of an ARSEI message.

At this point, the flowchart may be complete. In some embodiments, however, the flowchart may restart and/or certain blocks may be repeated. For example, in some embodiments, the flowchart may restart at block 802 to receive and encode another image or video frame.

### Example Computing Embodiments

Examples of various computing embodiments that may be used to implement the video/image compression solution described herein are provided below. In particular, any aspects of the solution described in the preceding sections may be implemented using the computing embodiments described below.

### Edge Computing

FIG. 9 is a block diagram 900 showing an overview of a configuration for edge computing, which includes a layer of processing referred to in many of the following examples as an “edge cloud”. As shown, the edge cloud 910 is co-located at an edge location, such as an access point or base station 940, a local processing hub 950, or a central office 920, and thus may include multiple entities, devices, and equipment instances. The edge cloud 910 is located much closer to the endpoint (consumer and producer) data sources 960 (e.g., autonomous vehicles 961, user equipment 962, business and industrial equipment 963, video capture devices 964, drones 965, smart cities and building devices 966, sensors and IoT devices 967, etc.) than the cloud data center 930. Compute, memory, and storage resources which are offered at the edges in the edge cloud 910 are critical to providing ultra-low latency response times for services and functions used by the endpoint data sources 960 as well as reduce network backhaul traffic from the edge cloud 910 toward cloud data center 930 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

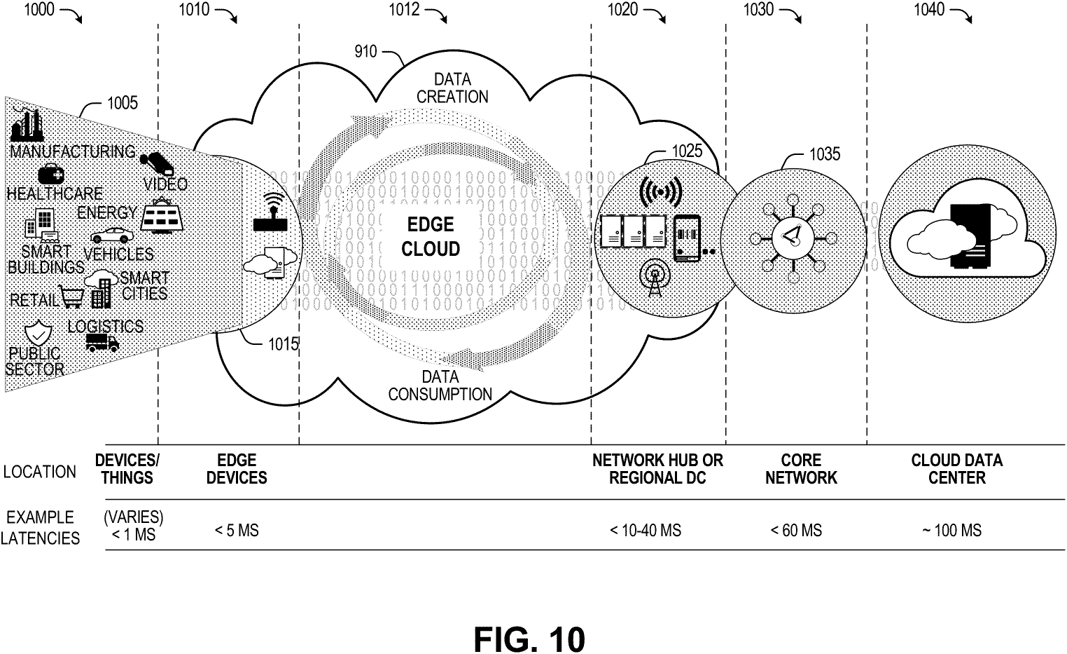

FIG. 10 illustrates operational layers among endpoints, an edge cloud, and cloud computing environments. Specifically, FIG. 10 depicts examples of computational use cases 1005, utilizing the edge cloud 910 among multiple illustrative layers of network computing. The layers begin at an endpoint (devices and things) layer 1000, which accesses the edge cloud 910 to conduct data creation, analysis, and data consumption activities. The edge cloud 910 may span multiple network layers, such as an edge devices layer 1010 having gateways, on-premise servers, or network equipment (nodes 1015) located in physically proximate edge systems; a network access layer 1020, encompassing base stations, radio processing units, network hubs, regional data centers (DC), or local network equipment (equipment 1025); and any equipment, devices, or nodes located therebetween (in layer 1012, not illustrated in detail). The network communications within the edge cloud 910 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1000, under 5 ms at the edge devices layer 1010, to even between 10 to 40 ms when communicating with nodes at the network access layer 1020. Beyond the edge cloud 910 are core network 1030 and cloud data center 1040 layers, each with increasing latency (e.g., between 50-60 ms at the core network layer 1030, to 100 or more ms at the cloud data center layer). As a result, operations at a core network data center 1035 or a cloud data center 1045, with latencies of at least 50 to 100 ms or more, will not be able to accomplish many time-critical functions of the use cases 1005. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1035 or a cloud data center 1045, a central office or content data network may be considered as being located within a “near edge” layer (“near” to the cloud, having high latency values when communicating with the devices and endpoints of the use cases 1005), whereas an access point, base station, on-premise server, or network gateway may be considered as located within a “far edge” layer (“far” from the cloud, having low latency values when communicating with the devices and endpoints of the use cases 1005). It will be understood that other categorizations of a particular network layer as constituting a “close”, “local”, “near”, “middle”, or “far” edge may be based on latency, distance, number of network hops, or other measurable characteristics, as measured from a source in any of the network layers 1000-1040.

The various use cases 1005 may access resources under usage pressure from incoming streams, due to multiple services utilizing the edge cloud. To achieve results with low latency, the services executed within the edge cloud 910 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 910 may provide the ability to serve and respond to multiple applications of the use cases 1005 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 910 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 910 (network layers 1000-1040), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 910.

As such, the edge cloud 910 is formed from network components and functional features operated by and within edge gateway nodes, edge aggregation nodes, or other edge compute nodes among network layers 1010-1030. The edge cloud 910 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 910 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

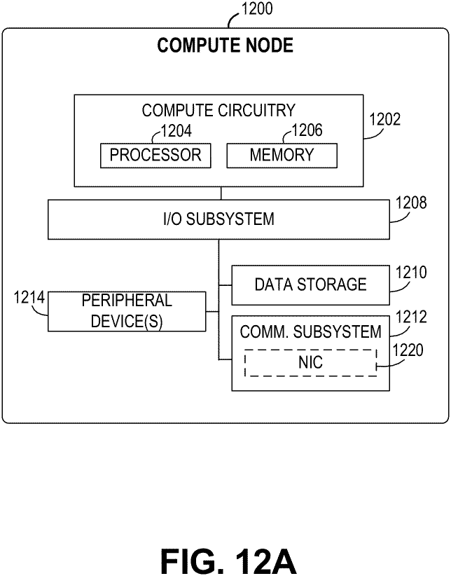

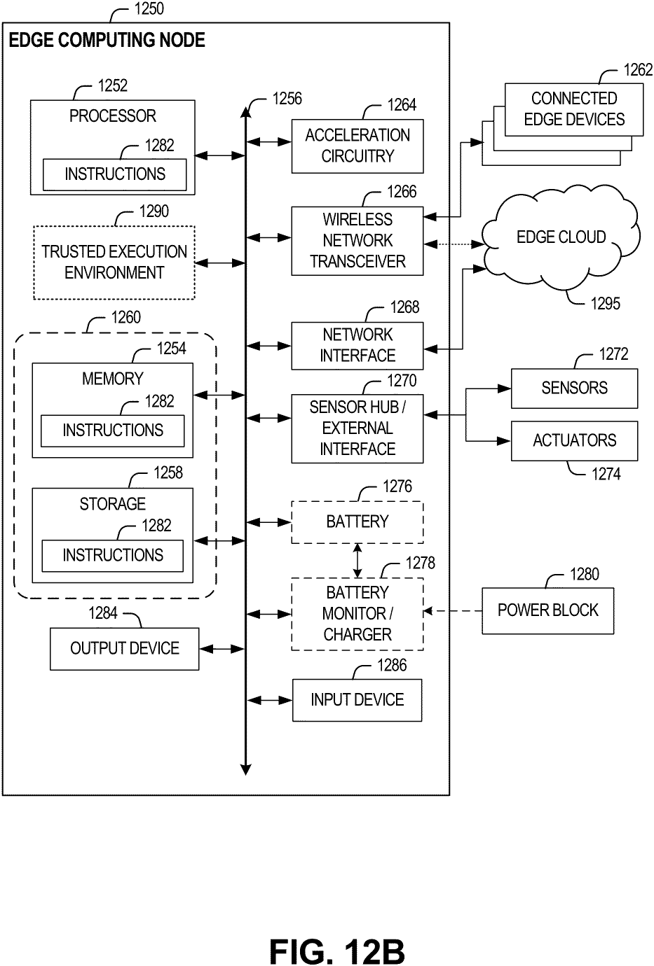

The network components of the edge cloud 910 may be servers, multi-tenant servers, appliance computing devices, and/or any other type of computing devices. For example, the edge cloud 910 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 12B. The edge cloud 910 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

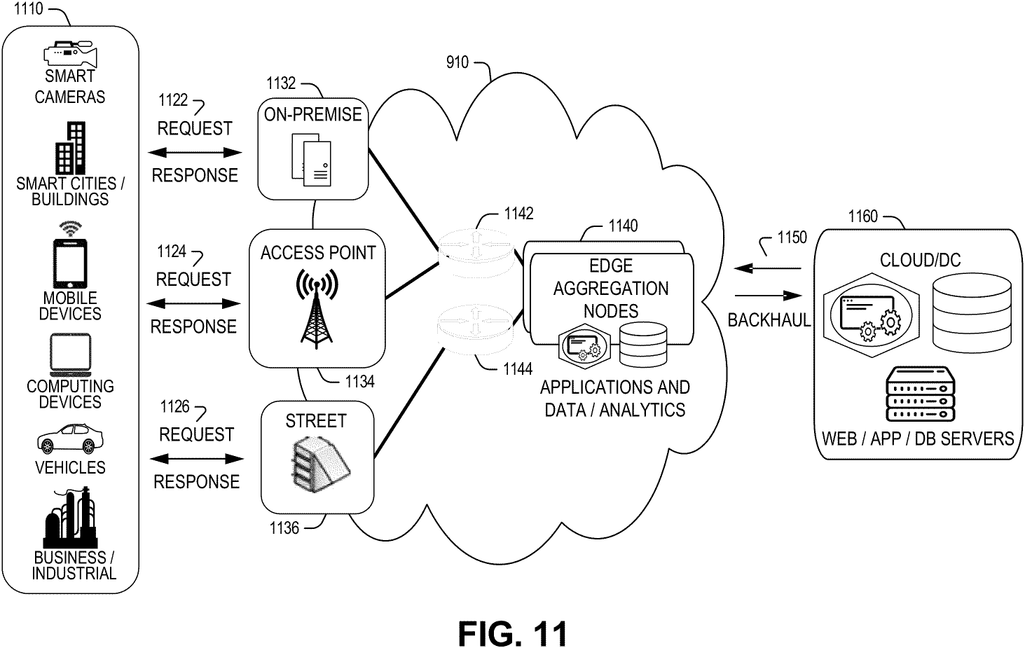

In FIG. 11, various client endpoints 1110 (in the form of smart cameras, mobile devices, computers, autonomous vehicles, business computing equipment, industrial processing equipment) exchange requests and responses that are specific to the type of endpoint network aggregation. For instance, client endpoints 1110 may obtain network access via a wired broadband network, by exchanging requests and responses 1122 through an on-premise network system 1132. Some client endpoints 1110, such as smart cameras, may obtain network access via a wireless broadband network, by exchanging requests and responses 1124 through an access point (e.g., cellular network tower) 1134. Some client endpoints 1110, such as autonomous vehicles may obtain network access for requests and responses 1126 via a wireless vehicular network through a street-located network system 1136. However, regardless of the type of network access, the TSP may deploy aggregation points 1142, 1144 within the edge cloud 910 to aggregate traffic and requests. Thus, within the edge cloud 910, the TSP may deploy various compute and storage resources, such as at edge aggregation nodes 1140, to provide requested content. The edge aggregation nodes 1140 and other systems of the edge cloud 910 are connected to a cloud or data center 1160, which uses a backhaul network 1150 to fulfill higher-latency requests from a cloud/data center for websites, applications, database servers, etc. Additional or consolidated instances of the edge aggregation nodes 1140 and the aggregation points 1142, 1144, including those deployed on a single server framework, may also be present within the edge cloud 910 or other areas of the TSP infrastructure.

### Computing Devices and Systems

In further examples, any of the compute nodes or devices discussed with reference to the present edge computing systems and environment may be fulfilled based on the components depicted in FIGS. 12A and 12B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 12A, an edge compute node 1200 includes a compute engine (also referred to herein as “compute circuitry”) 1202, an input/output (I/O) subsystem 1208, data storage 1210, a communication circuitry subsystem 1212, and, optionally, one or more peripheral devices 1214. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1200 may be embodied as any type of engine, device, or collection of devices capable of performing various compute functions. In some examples, the compute node 1200 may be embodied as a single device such as an integrated circuit, an embedded system, a field-programmable gate array (FPGA), a system-on-a-chip (SOC), or other integrated system or device. In the illustrative example, the compute node 1200 includes or is embodied as a processor 1204 and a memory 1206. The processor 1204 may be embodied as any type of processor capable of performing the functions described herein (e.g., executing an application). For example, the processor 1204 may be embodied as a multi-core processor(s), a microcontroller, a processing unit, a specialized or special purpose processing unit, or other processor or processing/controlling circuit.

In some examples, the processor 1204 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 1204 may work in coordination with each other to execute many types of operations and instructions within and on behalf of the compute node 1200.

The memory 1206 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1206 may be integrated into the processor 1204. The memory 1206 may store various software and data used during operation such as one or more applications, data operated on by the application(s), libraries, and drivers.

The compute circuitry 1202 is communicatively coupled to other components of the compute node 1200 via the I/O subsystem 1208, which may be embodied as circuitry and/or components to facilitate input/output operations with the compute circuitry 1202 (e.g., with the processor 1204 and/or the main memory 1206) and other components of the compute circuitry 1202. For example, the I/O subsystem 1208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1208 may form a portion of a system-on-a-chip (SoC) and be incorporated, along with one or more of the processor 1204, the memory 1206, and other components of the compute circuitry 1202, into the compute circuitry 1202.

The one or more illustrative data storage devices 1210 may be embodied as any type of devices configured for short-term or long-term storage of data such as, for example, memory devices and circuits, memory cards, hard disk drives, solid-state drives, or other data storage devices. Individual data storage devices 1210 may include a system partition that stores data and firmware code for the data storage device 1210. Individual data storage devices 1210 may also include one or more operating system partitions that store data files and executables for operating systems depending on, for example, the type of compute node 1200.

The communication circuitry 1212 may be embodied as any communication circuit, device, or collection thereof, capable of enabling communications over a network between the compute circuitry 1202 and another compute device (e.g., an edge gateway of an implementing edge computing system). The communication circuitry 1212 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1212 includes a network interface controller (NIC) 1220, which may also be referred to as a host fabric interface (HFI). The NIC 1220 may be embodied as one or more add-in-boards, daughter cards, network interface cards, controller chips, chipsets, or other devices that may be used by the compute node 1200 to connect with another compute device (e.g., an edge gateway node). In some examples, the NIC 1220 may be embodied as part of a system-on-a-chip (SoC) that includes one or more processors, or included on a multichip package that also contains one or more processors. In some examples, the NIC 1220 may include a local processor (not shown) and/or a local memory (not shown) that are both local to the NIC 1220. In such examples, the local processor of the NIC 1220 may be capable of performing one or more of the functions of the compute circuitry 1202 described herein. Additionally, or alternatively, in such examples, the local memory of the NIC 1220 may be integrated into one or more components of the client compute node at the board level, socket level, chip level, and/or other levels.

Additionally, in some examples, a respective compute node 1200 may include one or more peripheral devices 1214. Such peripheral devices 1214 may include any type of peripheral device found in a compute device or server such as audio input devices, a display, other input/output devices, interface devices, and/or other peripheral devices, depending on the particular type of the compute node 1200. In further examples, the compute node 1200 may be embodied by a respective edge compute node (whether a client, gateway, or aggregation node) in an edge computing system or like forms of appliances, computers, subsystems, circuitry, or other components.

In a more detailed example, FIG. 12B illustrates a block diagram of an example of components that may be present in an edge computing node 1250 for implementing the techniques (e.g., operations, processes, methods, and methodologies) described herein. This edge computing node 1250 provides a closer view of the respective components of node 1200 when implemented as or as part of a computing device (e.g., as a mobile device, a base station, server, gateway, etc.). The edge computing node 1250 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1250, or as components otherwise incorporated within a chassis of a larger system.

The edge computing device 1250 may include processing circuitry in the form of a processor 1252, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1252 may be a part of a system on a chip (SoC) in which the processor 1252 and other components are formed into a single integrated circuit, or a single package, such as the Edison™ or Galileo™ SoC boards from Intel Corporation, Santa Clara, California. As an example, the processor 1252 may include an Intel@ Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®–based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1252 and accompanying circuitry may be provided in a single socket form factor, multiple socket form factor, or a variety of other formats, including in limited hardware configurations or configurations that include fewer than all elements shown in FIG. 12B.

The processor 1252 may communicate with a system memory 1254 over an interconnect 1256 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1258 may also couple to the processor 1252 via the interconnect 1256. In an example, the storage 1258 may be implemented via a solid-state disk drive (SSDD). Other devices that may be used for the storage 1258 include flash memory cards, such as Secure Digital (SD) cards, microSD cards, extreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), antiferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1258 may be on-die memory or registers associated with the processor 1252. However, in some examples, the storage 1258 may be implemented using a micro hard disk drive (HDD). Further, any number of new technologies may be used for the storage 1258 in addition to, or instead of, the technologies described, such resistance change memories, phase change memories, holographic memories, or chemical memories, among others.

The components may communicate over the interconnect 1256. The interconnect 1256 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1256 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1256 may couple the processor 1252 to a transceiver 1266, for communications with the connected edge devices 1262. The transceiver 1266 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1262. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1266 (or multiple transceivers) may communicate using multiple standards or radios for communications at a different range. For example, the edge computing node 1250 may communicate with close devices, e.g., within about 10 meters, using a local transceiver based on Bluetooth Low Energy (BLE), or another low power radio, to save power. More distant connected edge devices 1262, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1266 (e.g., a radio transceiver) may be included to communicate with devices or services in a cloud (e.g., an edge cloud 1295) via local or wide area network protocols. The wireless network transceiver 1266 may be a low-power wide-area (LPWA) transceiver that follows the IEEE 802.15.4, or IEEE 802.15.4 g standards, among others. The edge computing node 1250 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1266, as described herein. For example, the transceiver 1266 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1266 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1268 may be included to provide a wired communication to nodes of the edge cloud 1295 or to other devices, such as the connected edge devices 1262 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1268 may be included to enable connecting to a second network, for example, a first NIC 1268 providing communications to the cloud over Ethernet, and a second NIC 1268 providing communications to other devices over another type of network.

Given the variety of types of applicable communications from the device to another component or network, applicable communications circuitry used by the device may include or be embodied by any one or more of components 1264, 1266, 1268, or 1270. Accordingly, in various examples, applicable means for communicating (e.g., receiving, transmitting, etc.) may be embodied by such communications circuitry.

The edge computing node 1250 may include or be coupled to acceleration circuitry 1264, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1256 may couple the processor 1252 to a sensor hub or external interface 1270 that is used to connect additional devices or subsystems. The devices may include sensors 1272, such as accelerometers, level sensors, flow sensors, optical light sensors, camera sensors, temperature sensors, global navigation system (e.g., GPS) sensors, pressure sensors, barometric pressure sensors, and the like. The hub or interface 1270 further may be used to connect the edge computing node 1250 to actuators 1274, such as power switches, valve actuators, an audible sound generator, a visual warning device, and the like.

In some optional examples, various input/output (I/O) devices may be present within or connected to, the edge computing node 1250. For example, a display or other output device 1284 may be included to show information, such as sensor readings or actuator position. An input device 1286, such as a touch screen or keypad may be included to accept input. An output device 1284 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1250. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1276 may power the edge computing node 1250, although, in examples in which the edge computing node 1250 is mounted in a fixed location, it may have a power supply coupled to an electrical grid, or the battery may be used as a backup or for temporary capabilities. The battery 1276 may be a lithium ion battery, or a metal-air battery, such as a zinc-air battery, an aluminum-air battery, a lithium-air battery, and the like.

A battery monitor/charger 1278 may be included in the edge computing node 1250 to track the state of charge (SoCh) of the battery 1276, if included. The battery monitor/charger 1278 may be used to monitor other parameters of the battery 1276 to provide failure predictions, such as the state of health (SoH) and the state of function (SoF) of the battery 1276. The battery monitor/charger 1278 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1278 may communicate the information on the battery 1276 to the processor 1252 over the interconnect 1256. The battery monitor/charger 1278 may also include an analog-to-digital (ADC) converter that enables the processor 1252 to directly monitor the voltage of the battery 1276 or the current flow from the battery 1276. The battery parameters may be used to determine actions that the edge computing node 1250 may perform, such as transmission frequency, mesh network operation, sensing frequency, and the like.

A power block 1280, or other power supply coupled to a grid, may be coupled with the battery monitor/charger 1278 to charge the battery 1276. In some examples, the power block 1280 may be replaced with a wireless power receiver to obtain the power wirelessly, for example, through a loop antenna in the edge computing node 1250. A wireless battery charging circuit, such as an LTC4020 chip from Linear Technologies of Milpitas, California, among others, may be included in the battery monitor/charger 1278. The specific charging circuits may be selected based on the size of the battery 1276, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1258 may include instructions 1282 in the form of software, firmware, or hardware commands to implement the techniques described herein. Although such instructions 1282 are shown as code blocks included in the memory 1254 and the storage 1258, it may be understood that any of the code blocks may be replaced with hardwired circuits, for example, built into an application specific integrated circuit (ASIC).

In an example, the instructions 1282 provided via the memory 1254, the storage 1258, or the processor 1252 may be embodied as a non-transitory, machine-readable medium 1260 including code to direct the processor 1252 to perform electronic operations in the edge computing node 1250. The processor 1252 may access the non-transitory, machine-readable medium 1260 over the interconnect 1256. For instance, the non-transitory, machine-readable medium 1260 may be embodied by devices described for the storage 1258 or may include specific storage units such as optical disks, flash drives, or any number of other hardware devices. The non-transitory, machine-readable medium 1260 may include instructions to direct the processor 1252 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1282 on the processor 1252 (separately, or in combination with the instructions 1282 of the machine readable medium 1260) may configure execution or operation of a trusted execution environment (TEE) 1290. In an example, the TEE 1290 operates as a protected area accessible to the processor 1252 for secure execution of instructions and secure access to data. Various implementations of the TEE 1290, and an accompanying secure area in the processor 1252 or the memory 1254 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1250 through the TEE 1290 and the processor 1252.

### Machine-Readable Medium and Distributed Software Instructions

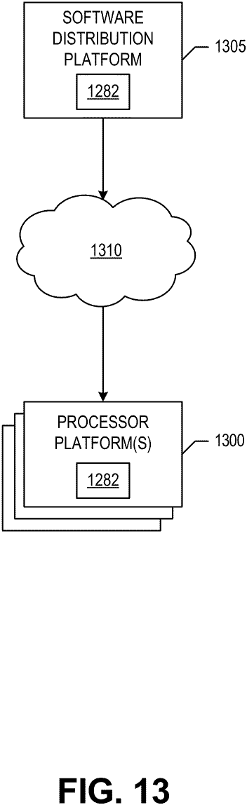

FIG. 13 illustrates an example software distribution platform 1305 to distribute software, such as the example computer readable instructions 1282 of FIG. 12B, to one or more devices, such as example processor platform(s) 1300 and/or example connected edge devices described throughout this disclosure. The example software distribution platform 1305 may be implemented by any computer server, data facility, cloud service, etc., capable of storing and transmitting software to other computing devices (e.g., third parties, example connected edge devices described throughout this disclosure). Example connected edge devices may be customers, clients, managing devices (e.g., servers), third parties (e.g., customers of an entity owning and/or operating the software distribution platform 1305). Example connected edge devices may operate in commercial and/or home automation environments. In some examples, a third party is a developer, a seller, and/or a licensor of software such as the example computer readable instructions 1282 of FIG. 12B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 13, the software distribution platform 1305 includes one or more servers and one or more storage devices. The storage devices store the computer readable instructions 1282, which may implement the computer vision pipeline functionality described throughout this disclosure. The one or more servers of the example software distribution platform 1305 are in communication with a network 1310, which may correspond to any one or more of the Internet and/or any of the example networks described throughout this disclosure. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1282 from the software distribution platform 1305. For example, software comprising the computer readable instructions 1282 may be downloaded to the example processor platform(s) 1300 (e.g., example connected edge devices), which is/are to execute the computer readable instructions 1282 to implement the functionality described throughout this disclosure. In some examples, one or more servers of the software distribution platform 1305 are communicatively connected to one or more security domains and/or security devices through which requests and transmissions of the example computer readable instructions 1282 must pass. In some examples, one or more servers of the software distribution platform 1305 periodically offer, transmit, and/or force updates to the software (e.g., the example computer readable instructions 1282 of FIG. 12B) to ensure improvements, patches, updates, etc. are distributed and applied to the software at the end user devices.

In the illustrated example of FIG. 13, the computer readable instructions 1282 are stored on storage devices of the software distribution platform 1305 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1282 stored in the software distribution platform 1305 are in a first format when transmitted to the example processor platform(s) 1300. In some examples, the first format is an executable binary in which particular types of the processor platform(s) 1300 can execute. However, in some examples, the first format is uncompiled code that requires one or more preparation tasks to transform the first format to a second format to enable execution on the example processor platform(s) 1300. For instance, the receiving processor platform(s) 1300 may need to compile the computer readable instructions 1282 in the first format to generate executable code in a second format that is capable of being executed on the processor platform(s) 1300. In still other examples, the first format is interpreted code that, upon reaching the processor platform(s) 1300, is interpreted by an interpreter to facilitate execution of instructions.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes at least one non-transitory machine-readable storage medium having instructions stored thereon, wherein the instructions, when executed on processing circuitry, cause the processing circuitry to: receive visual data in a first format, wherein the first format corresponds to a first color space having a first bit depth, wherein the visual data is represented in the first color space; rearrange the visual data from the first format into a second format, wherein the second format corresponds to a second color space having a second bit depth, wherein the second color space is different from the first color space, and wherein the rearranged visual data in the second format is represented in the first color space; and encode the rearranged visual data in the second format using a codec for the second color space, wherein the rearranged visual data is encoded into encoded visual data.

Example 2 includes the storage medium of Example 1, wherein the visual data is: an image; a video frame; or a tile of an image or a video frame.

Example 3 includes the storage medium of any of Examples 1-2, wherein: the first color space is a monochrome color space; and the second color space is a luminance-chrominance color space or a red-green-blue (RGB) color space.

Example 4 includes the storage medium of Example 3, wherein: the second color space is the luminance-chrominance color space, wherein the luminance-chrominance color space is a YCbCr color space; the first bit depth is at least 16 bits per pixel; and the second bit depth is at least 8 bits per color component.

Example 5 includes the storage medium of any of Examples 1-2, wherein: the first color space is a monochrome color space; the second color space is a luminance-chrominance color space; and the instructions that cause the processing circuitry to rearrange the visual data from the first format into the second format further cause the processing circuitry to: partition bits of pixel values in a monochrome channel of the first format into a luma channel, a blue chroma channel, and a red chroma channel of the second format.

Example 6 includes the storage medium of any of Examples 1-5, wherein pixels of the rearranged visual data in the second format are rotated relative to pixels of the visual data in the first format.

Example 7 includes the storage medium of any of Examples 1-6, wherein the instructions that cause the processing circuitry to rearrange the visual data from the first format into the second format further cause the processing circuitry to: compute one or more metrics associated with the visual data in the first format, wherein the one or more metrics include at least one of a sum of adjacent pixel error or a color conversion suitability factor; and select the second format for encoding the visual data, wherein the second format is selected from a plurality of color space formats based on the one or more metrics.

Example 8 includes the storage medium of any of Examples 1-7, wherein the encoded visual data includes metadata indicating a source format and a target format of the visual data, wherein the source format is the first format and the target format is the second format.

Example 9 includes the storage medium of Example 8, wherein the encoded visual data further includes an annotated regions supplemental enhancement information (SEI) message, wherein the annotated regions SEI message includes the metadata.

Example 10 includes the storage medium of any of Examples 1-9, wherein the visual data is medical image data.

Example 11 includes the storage medium of any of Examples 1-10, wherein the codec is based on H.264, H.265, AV1, VP9, JPEG, or 7-Zip.

Example 12 includes an electronic device, comprising: interface circuitry; and processing circuitry to: receive, via the interface circuitry, visual data in a first format, wherein the first format corresponds to a first color space having a first bit depth, wherein the visual data is represented in the first color space; rearrange the visual data from the first format into a second format, wherein the second format corresponds to a second color space having a second bit depth, wherein the second color space is different from the first color space, and wherein the rearranged visual data in the second format is represented in the first color space; and encode the rearranged visual data in the second format using a codec for the second color space, wherein the rearranged visual data is encoded into encoded visual data.

Example 13 includes the electronic device of Example 12, wherein: the first color space is a monochrome color space; and the second color space is a luminance-chrominance color space or a red-green-blue (RGB) color space.

Example 14 includes the electronic device of Example 12, wherein: the first color space is a monochrome color space; the second color space is a luminance-chrominance color space; and the processing circuitry to rearrange the visual data from the first format into the second format is further to: partition bits of pixel values in a monochrome channel of the first format into a luma channel, a blue chroma channel, and a red chroma channel of the second format.

Example 15 includes the electronic device of any of Examples 12-14, wherein pixels of the rearranged visual data in the second format are rotated relative to pixels of the visual data in the first format.

Example 16 includes the electronic device of any of Examples 12-15, wherein the processing circuitry to rearrange the visual data from the first format into the second format is further to: compute one or more metrics associated with the visual data in the first format, wherein the one or more metrics include at least one of a sum of adjacent pixel error or a color conversion suitability factor; and select the second format for encoding the visual data, wherein the second format is selected from a plurality of color space formats based on the one or more metrics.

Example 17 includes the electronic device of any of Examples 12-16, wherein the encoded visual data includes metadata indicating a source format and a target format of the visual data, wherein the source format is the first format and the target format is the second format.

Example 18 includes the electronic device of any of Examples 12-17, wherein the codec is based on H.264, H.265, AV1, VP9, JPEG, or 7-Zip.

Example 19 includes a method, comprising: receiving visual data in a first format, wherein the first format corresponds to a first color space having a first bit depth, wherein the visual data is represented in the first color space; rearranging the visual data from the first format into a second format, wherein the second format corresponds to a second color space having a second bit depth, wherein the second color space is different from the first color space, and wherein the rearranged visual data in the second format is represented in the first color space; and encoding the rearranged visual data in the second format using a codec for the second color space, wherein the rearranged visual data is encoded into encoded visual data.

Example 20 includes the method of Example 19, wherein: the first color space is a monochrome color space; the second color space is a luminance-chrominance color space; and rearranging the visual data from the first format into the second format comprises: partitioning bits of pixel values in a monochrome channel of the first format into a luma channel, a blue chroma channel, and a red chroma channel of the second format.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

1. At least one non-transitory machine-readable storage medium having instructions stored thereon, wherein the instructions, when executed on processing circuitry, cause the processing circuitry to:
receive visual data in a first format, wherein the first format corresponds to a first color space having a first bit depth, wherein the visual data is represented in the first color space;
rearrange the visual data from the first format into a second format, wherein the second format corresponds to a second color space having a second bit depth, wherein the second color space is different from the first color space, and wherein the rearranged visual data in the second format is represented in the first color space; and
encode the rearranged visual data in the second format using a codec for the second color space, wherein the rearranged visual data is encoded into encoded visual data.

2. The storage medium of claim 1, wherein the visual data is:
an image;
a video frame; or
a tile of an image or a video frame.

3. The storage medium of claim 1, wherein:
the first color space is a monochrome color space; and
the second color space is a luminance-chrominance color space or a red-green-blue (RGB) color space.

4. The storage medium of claim 3, wherein:
the second color space is the luminance-chrominance color space, wherein the luminance-chrominance color space is a YCbCr color space;
the first bit depth is at least 16 bits per pixel; and
the second bit depth is at least 8 bits per color component.

5. The storage medium of claim 1, wherein:
the first color space is a monochrome color space;
the second color space is a luminance-chrominance color space; and
the instructions that cause the processing circuitry to rearrange the visual data from the first format into the second format further cause the processing circuitry to:
partition bits of pixel values in a monochrome channel of the first format into a luma channel, a blue chroma channel, and a red chroma channel of the second format.

6. The storage medium of claim 1, wherein pixels of the rearranged visual data in the second format are rotated relative to pixels of the visual data in the first format.

7. The storage medium of claim 1, wherein the instructions that cause the processing circuitry to rearrange the visual data from the first format into the second format further cause the processing circuitry to:
compute one or more metrics associated with the visual data in the first format, wherein the one or more metrics include at least one of a sum of adjacent pixel error or a color conversion suitability factor; and
select the second format for encoding the visual data, wherein the second format is selected from a plurality of color space formats based on the one or more metrics.

8. The storage medium of claim 1, wherein the encoded visual data includes metadata indicating a source format and a target format of the visual data, wherein the source format is the first format and the target format is the second format.

9. The storage medium of claim 8, wherein the encoded visual data further includes an annotated regions supplemental enhancement information (SEI) message, wherein the annotated regions SEI message includes the metadata.

10. The storage medium of claim 1, wherein the visual data is medical image data.

11. The storage medium of claim 1, wherein the codec is based on H.264, H.265, AV1, VP9, JPEG, or 7-Zip.

12. An electronic device, comprising:
interface circuitry; and
processing circuitry to:
receive, via the interface circuitry, visual data in a first format, wherein the first format corresponds to a first color space having a first bit depth, wherein the visual data is represented in the first color space;
rearrange the visual data from the first format into a second format, wherein the second format corresponds to a second color space having a second bit depth, wherein the second color space is different from the first color space, and wherein the rearranged visual data in the second format is represented in the first color space; and
encode the rearranged visual data in the second format using a codec for the second color space, wherein the rearranged visual data is encoded into encoded visual data.

13. The electronic device of claim 12, wherein:
the first color space is a monochrome color space; and
the second color space is a luminance-chrominance color space or a red-green-blue (RGB) color space.

14. The electronic device of claim 12, wherein:
the first color space is a monochrome color space;
the second color space is a luminance-chrominance color space; and
the processing circuitry to rearrange the visual data from the first format into the second format is further to:
partition bits of pixel values in a monochrome channel of the first format into a luma channel, a blue chroma channel, and a red chroma channel of the second format.

15. The electronic device of claim 12, wherein pixels of the rearranged visual data in the second format are rotated relative to pixels of the visual data in the first format.

16. The electronic device of claim 12, wherein the processing circuitry to rearrange the visual data from the first format into the second format is further to:
compute one or more metrics associated with the visual data in the first format, wherein the one or more metrics include at least one of a sum of adjacent pixel error or a color conversion suitability factor; and
select the second format for encoding the visual data, wherein the second format is selected from a plurality of color space formats based on the one or more metrics.

17. The electronic device of claim 12, wherein the encoded visual data includes metadata indicating a source format and a target format of the visual data, wherein the source format is the first format and the target format is the second format.

18. The electronic device of claim 12, wherein the codec is based on H.264, H.265, AV1, VP9, JPEG, or 7-Zip.

19. A method, comprising:
receiving visual data in a first format, wherein the first format corresponds to a first color space having a first bit depth, wherein the visual data is represented in the first color space;
rearranging the visual data from the first format into a second format, wherein the second format corresponds to a second color space having a second bit depth, wherein the second color space is different from the first color space, and wherein the rearranged visual data in the second format is represented in the first color space; and
encoding the rearranged visual data in the second format using a codec for the second color space, wherein the rearranged visual data is encoded into encoded visual data.

20. The method of claim 19, wherein:
the first color space is a monochrome color space;
the second color space is a luminance-chrominance color space; and
rearranging the visual data from the first format into the second format comprises:
partitioning bits of pixel values in a monochrome channel of the first format into a luma channel, a blue chroma channel, and a red chroma channel of the second format.
